(19) United States
(12) Patent Application Publication
(10) Pub. No.: US 2026/0188597 A1
(43) Pub. Date: Jul. 2, 2026

(54) Flexible super-capacitors

(71) Applicant: The American University in Cairo, New York, NY (US)

(72) Inventors: Nageh K. Allam, New Cairo (EG); Loujain G. Ghanem, New Cairo (EG); Basamat S. Shaheen, Cairo (EG)

(21) Appl. No.: 18/728,232

(22) PCT Filed: Jan. 13, 2023
(86) PCT No.: PCT/US2023/010751

§ 371 Date: Jul. 11, 2024

Related U.S. Application Data
(60) Provisional application No. 63/299,270, filed on Jan. 13, 2022.

(51) Int. Cl. H01G 9/15; H01G 9/032; H01G 9/042; H01G 11/34; H01G 11/56

(52) U.S. Cl. CPC H01G 9/153; H01G 9/032; H01G 9/042; H01G 11/34; H01G 11/56

(57) ABSTRACT

A solid-state supercapacitor [100] is composed of a solid-state electrolyte [106] made of an electrospun nanofiber sheet impregnated with a salt; and a symmetric pair of electrode sheets [102, 104]. The solid-state electrolyte [106] is sandwiched between and in contact with the symmetric pair of electrode sheets [102, 104] such that the solid-state electrolyte separates the electrode sheets from each other. Preferably, each of the symmetric pair of electrode sheets [102, 104] is composed of commercial activated carbon on a graphite substrate, and the salt is preferably a salt of Li, Cs or Rb, such as LiCl.

### FIELD OF THE INVENTION

The present invention generally relates to electric capacitor devices. More specifically, it relates to supercapacitors.

### BACKGROUND OF THE INVENTION

The fabrication of miniaturized electrochemical energy storage systems is essential for the development of future electronic devices for Internet of Things (IoT) applications, where connected devices 1 are increasingly deployed in our daily life. The IoT market is rapidly growing. There were over 31 billion IoT devices installed last year. Batteries are a chief concern for such devices. Rechargeable or not, they are a single point of failure with short service life. It is expensive to change these batteries, especially for devices in remote locations (such as a street light pole).

A solution to replace or extend the service life of batteries is needed. A challenge for such solutions is to integrate seamlessly into the IoT infrastructure and maintain its discrete form factor. In this regard, on-chip supercapacitors are an attractive solution to fulfill the energy requirements of autonomous, smart, maintenance free, and miniaturized sensors. However, existing on-chip supercapacitors suffer from poor technological readiness level in spite of high power capabilities and long cycle life.

### SUMMARY OF THE INVENTION

Described herein are flexible solid-salt in fiber supercapacitors that may be bent inside small product enclosures or distributed inside a power cord. This can make the IoT device smaller, but more importantly can keep the IoT device out of sight and out of mind. These flexible supercapacitors can save thousands of dollars over their service life. Moreover, these flexible supercapacitors enjoy other advantages, such as extending the range of communication, especially for cellular and Wi-Fi based IoT devices. Specifically, for future cities, the city of the future should be smart and beautiful. Street lamps are becoming a platform for 5G and IoT. Batteries and traditional supercapacitors take up a lot of space, creating an eyesore for the city. IoT devices, such as gunshot triangulation, must seamlessly integrated and hidden for mass adoption, which will be possible upon the use of flexible supercapacitors.

These flexible supercapacitors are designed to be discrete, powerful, and expansive offering space saving advantages over traditional capacitor energy storage technologies. For example, these flexible supercapacitors enjoy other advantages, such as extending the range of communication, especially for cellular and Wi-Fi based IoT devices. This will enable users to offer better, smaller products with new capabilities, which further distinguishes their offering in the marketplace.

A battery may not seem expensive at first, but that changes when that battery needs to be replaced every 2.5 years. For an IoT system with 200 battery powered devices, pairing these flexible supercapacitors with an energy harvesting module will save thousands of dollars over its service life. These flexible cable-based supercapacitors provide an advantage in that they can be bent inside small product enclosures or distributed inside a power cord. This keeps the devices smaller in size while enjoying reduced cost and high energy/power density.

Our solution is based on the fabrication of flexible cable-based supercapacitors that can replace the currently used batteries. This will make the IoT technology cheaper, while maintaining the concise structure of the IoT devices, and providing more benefits. For example, a cornerstone of the IoT market is its connectivity. Connectivity is limited by how far the signals can travel. Leveraging the supercapacitor's power density can help extend the range of communication, especially for cellular and Wi-Fi based IoT devices. Moreover, IoT devices, such as those to monitor weather conditions on bridges and wind turbines, are battery powered and difficult (often dangerous) to reach. Pairing Flexible supercapacitors with an energy harvesting device can replace those batteries to reduce their cost and increase their safety.

In one aspect, the invention provides a solid-state super capacitor comprising a solid-state electrolyte consisting of an electrospun nanofiber sheet impregnated with a salt; and a symmetric pair of electrode sheets; wherein the solid-state electrolyte is sandwiched between and in contact with the symmetric pair of electrode sheets such that the solid-state electrolyte separates the electrode sheets from each other. Preferably, each of the symmetric pair of electrode sheets is composed of commercial activated carbon on a graphite substrate. Preferably, the salt is a salt of Li, Cs or Rb. Most preferably, the salt is LiCl.

### BRIEF DESCRIPTION OF THE DRAWINGS

FIG. 1 is a schematic illustrating a solid-state flexible supercapacitor and the method of fabricating the same.

FIG. 2A is a field emission scanning electron microscope (FE-SEM) image of the fabricated LiCl nanofibers (LCNF).

FIG. 2B is an energy-dispersive X-ray (EDX) elemental mapping of the fabricated LiCl nanofibers (LCNF).

FIGS. 2A, 2B are current-voltage and galvanostatic charge-discharge graphs, respectively, of the commercial activated carbon (CAC)/LCNF/CAC device operating at different potential windows

FIG. 3C shows variation of the specific capacitance and energy density with the potential window of the CAC/LCNF/CAC device.

FIG. 4A shows a CV graph at different scan rates from (5-100 mV/s).

FIG. 4B is a graph of rate capability from the CV for CAC/LCNF/CAC and CAC/aqueous (AQ) electrolyte/CAC.

FIG. 4C is a GCD graph at different current densities from (1-5 A/g).

FIG. 4D is a graph of rate capability from GCD for CAC/LCNF/CAC and CAC/AQ/CAC.

FIG. 5A is a Ragon's plot of the power density and the corresponding energy density.

FIG. 5B is a plot showing cyclic performance at 3 A/g.

FIG. 5C is a Nyquist plot of the CAC/LCNF/CAC device before and after cyclic stability.

FIG. 5D is a current-voltage graph corresponding to linear and bending conditions.

FIG. 6 shows current-voltage graphs at different operating potential windows of the assembled CAC/AQ/CAC device.

FIG. 7A shows current-voltage graphs at different scan rates (5-100 mV/s).

FIG. 7B shows GCD graphs at different current densities (1-5 A/g) for the assembled AC/AQ/CAC devices.

FIG. 8 is a schematic diagram showing an impedance equivalent circuit of the device.

### DETAILED DESCRIPTION

Described herein is a flexible solid-state supercapacitor that stores energy in a wire-like form factor designed to be built inside of power cords. It can also be used to offset capacitors from the circuit board to the wiring infrastructure in order to reduce the size of electronics. The flexible supercapacitors may be designed to be flexible, discrete, powerful, and expansive, offering space-saving advantages over traditional capacitor energy storage technologies. This enables users to offer better, smaller products with new capabilities, which further distinguishes their offering in the marketplace.

The flexible solid-state supercapacitors described herein may be made by fabrication of electrospun salt in nanofibers layers that act as both separator and electrolyte (source of ions). The flexible solid-state supercapacitors described herein may be made by constructing efficient solid electrolytes and separators by facile electrospinning method. The electrospun slat in fiber thin sheets provides superior performance compared to aqueous electrolytes, due to the wider operating potential window. These techniques provide flexible solid-state supercapacitors that can be used in portable and wearable electronics in contrast to the other highly toxic and costly electrolytes.

In contrast to supercapacitors using aqueous electrolytes, the flexible solid-state supercapacitors described herein use solid-state electrolytes. In addition, while existing techniques use electrospinning to fabricate efficient designs for the electrode's active material, such electrospinning techniques were not used previously to fabricate the electrolytes themselves. In the flexible solid-state supercapacitors described herein, it is important to emphasize that the electrospun sheets have a dual function: an electrolyte and a separator at the same time.

Conventionally, flexible supercapacitors are based on gel-electrolytes, which are composed of polymers and salts (alkaline, neutral, and acidic). They usually need the addition of an artificial separator in order to avoid any possible short circuit that increases the system's internal resistance and causes deterioration of the ions' diffusion. However, polymer-gel electrolytes have a limited operating potential window same as aqueous electrolytes-based devices. This can be ascribed to the water content that causes parasitic side reactions. In contrast, our electrospun membranes have dual functions: electrolyte and separator with no existence of liquids, which widen their operating potential window without any noticeable side reactions.

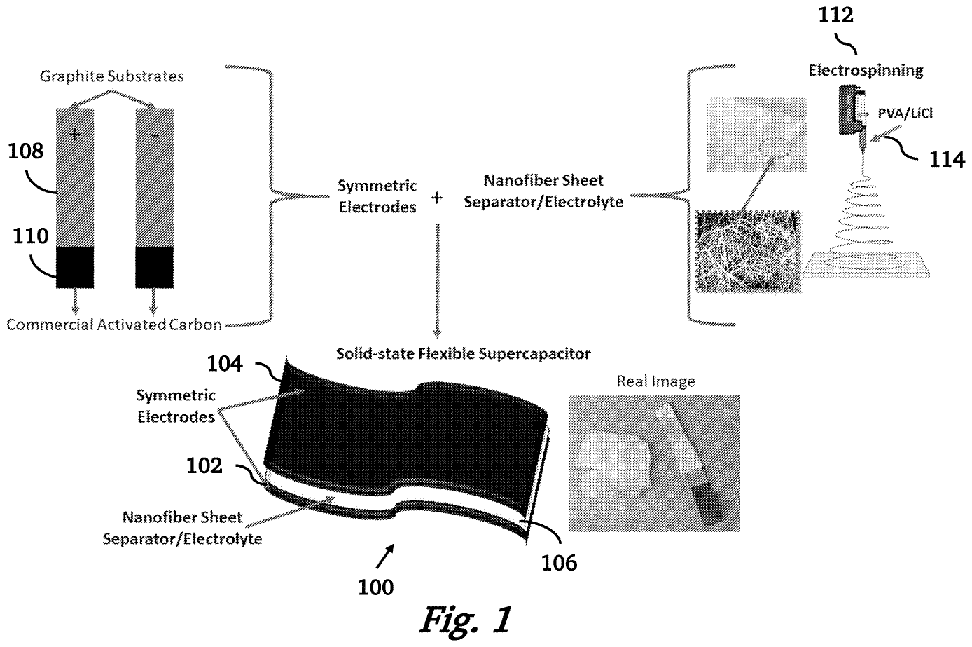

FIG. 1 is a schematic illustrating a solid-state flexible supercapacitor and the method of fabricating the same. The solid-state flexible supercapacitor 100 in this embodiment has the form of a salt-in-fiber nanofiber sheet 106 sandwiched between a pair of symmetric electrodes 102 and 104. In a preferred embodiment, each of electrodes 102 and 104 is made using a graphite substrate 108 and commercial activated carbon 110. The nanofiber sheet 106 is made by an electrospinning process 112 and impregnation 114 of the electrospun nanofiber with a salt such as LiCl.

The device may be operated using SP300 potentiostate/galvanostate terminals connected to the positive and negative poles of the activated carbon based electrodes 102 and 104. For the operation and usage, the supercapacitors described herein may be used with different mechanisms according to the type of the electrodes (Electric double-layer or battery-like or hybrid). However, the same testing protocol is used to measure the electrochemical performance under bend or twist conditions.

In one embodiment, the electrodes 102 and 104 are preferably formed of a substrate 108 (e.g., graphite) with dimensions of 10×10×0.3 mm. Then, we coat the substrate with a layer of the active material 110 (e.g., commercial activated carbon) with thicknesses ranging from tens of nanometers to a few micrometers to guarantee better storage of ions. Different fabrication methods may be used, such as drop-casting, which is used to fabricate a thin layer of active material on the substrate surface. The main advantage of such a method is obtaining low loading of active material. However, this method is commonly applied to EDL-based materials. On the other hand, spray coating is to fabricate layers with a maximum mass loading of 1 mg. This technique is usually applied to battery-like materials.

For the fabrication process of flexible solid supercapacitors, according to one method, electrodes are combined together after adding the gel electrolyte by drop-casting, or they are coated using printing techniques, like 3D printing.

The preferred size of the nanofiber sheet 106 is 2.5×1 cm to be able to wrap it around the positive and negative electrodes together. The thickness of the produced nanofiber sheet is controlled to be in the micron range to reduce the resistance.

The preferred concentrations of LiCl in the nanofiber sheet 106 are varying from 0.1 to 1.0 M of LiCl in poly(vinyl alcohol) (PVA) (Mol. Wt.=85,000-124,000). However, to guarantee better spin-ability with consistency in fiber diameter, we preferably use concentrations ≤0.3 M LiCl. The inventors envision in some embodiments to increase this concentration while maintaining the fibrous nature.

Fibers in the sheet 106 are randomly distributed (network), but they have uniform diameter distribution ranging from 400-600 nm. Freshly spun sheets are preferred for better ionic diffusion. They preferably have a network distribution with diameters less than 700 nm.

The inventors envision that the solid electrolyte impregnated in the sheet 106 may be composed of cesium and rubidium salts with other polymers for the same purpose. In fact, salts of Cs and Rb are envisioned to be better than those of Li. Other suitable polymers include Polycaprolactone (PCL), Polyaniline, and natural polymers such as Cellulose and Silk.

The electrodes 102 and 104 may be composed of activated carbon electrodes as they are widely used in industry. However, the inventors envision that solid-state electrospun devices may be based on metal oxide electrodes, such as Ni—Mn and Mn—V systems. For substrates, carbon paper and carbon cloth can be used.

The sheet 106 is preferably wrapped and well pressed together with the electrodes to ensure its success as a separator and electrolyte.

Following are additional details regarding the properties and methods to fabricate 0.1 M LiCl electrospun electrolyte, according to one embodiment of the invention. A solid-state supercapacitor 100 was assembled using the LiCl-containing nanofiber sheet 106 as both an electrolyte and separator with commercial activated carbon as positive and negative electrodes 102, 104.

The morphology and chemical composition of the electrolyte was revealed by scanning electron microscope and energy-dispersive X-ray. The electrochemical properties of the solid-state supercapacitor were characterized by cyclic voltammetry, galvanostatic charge-discharge, and electrochemical impedance spectroscopy techniques. Additionally, the performance of the supercapacitor device with the nanofiber electrolyte was compared with that of the aqueous electrolyte-based device. The supercapacitor with the LiCl nanofiber electrolyte exhibited an extended potential window of 2.3 V compared to 1.8 V for the aqueous-based device. Consequently, the specific capacitance and energy density were increased by 23.7% and 59%, respectively.

Supercapacitors conventionally are constructed of two electrodes with current collectors, a separator, and an electrolyte. According to the charge storage mechanism, supercapacitors are classified into three categories: electric double-layer capacitors (EDLCs), pseudocapacitors, and hybrid capacitors. In EDLCs, energy is stored by charge accumulation at the electrode/electrolyte interface. Activated carbon is the most widely used commercial electrode material for the electrostatic interaction in EDLCs due to its high specific surface area, availability, and low cost. On the other hand, electrolytes play a fundamental role in the charge storage process by providing ionic conductivity and facilitating charge transfer and balance between the two electrodes. Besides, the electrolyte determines the operating potential window of the supercapacitor at which it is stable and not degrading. The energy stored in a supercapacitor is proportional to the square of the operating voltage window according to the formula: E=½ CV², where E is the energy, C is the device capacitance, and V is the operating voltage window. Although most of the research efforts are focused on developing new active materials and composites for high capacitance electrodes, increasing the operating voltage window is more crucial to improve the energy density of supercapacitors. Therefore, developing new electrolytes with wide potential windows should render the supercapacitor devices more functional. Generally, electrolytes are classified into liquid, solid, and quasi-solid-state electrolytes. The use of liquid electrolytes requires very careful sealing of the device, which adds more volume and weight to the supercapacitor device. Therefore, despite their high ionic conductivity, liquid electrolytes are unsuitable for ultrathin, light weight, and flexible supercapacitors required for portable and wearable electronics. To this end, solid or quasi-solid electrolytes have emerged as alternatives to liquid electrolytes for more reliability and design flexibility. Polymer electrolytes, a type of solid electrolyte, have been showing a promising performance. They are prepared by mixing a polymer with a salt without any solvents, where the ions move through the polymer chains. Other polymer electrolytes are in the form of gel in which polymer network envelopes a liquid electrolyte and prevents it from escaping. Gel electrolytes has grasped more attention than dry polymer electrolytes due to their higher ionic conductivity because of the contained liquid, and the possibility of their direct application on the electrodes, minimizing the interfacial resistance. However, it is believed that dry polymers that can be pressed between electrodes as free-standing films acting as electrolyte and separator can offer more mechanically robust and flexible devices. To this end, fiber-shaped materials have been studied as supercapacitor electrodes, revealing the effect of the unique fibrous morphology on enhancing the electrochemical performance.

Described herein are electrospun PVA/LiCl nanofibrous thin sheets that are fabricated and tested as electrolyte and separator in symmetric activated carbon-based solid-state flexible supercapacitor devices. The constructed supercapacitors show superior performance compared to their aqueous electrolyte-based devices, mainly due to the wider operating potential window of the solid nanofibrous electrolyte. As a result, the specific capacitance and energy density are increased by 23.7% and 59%, respectively.

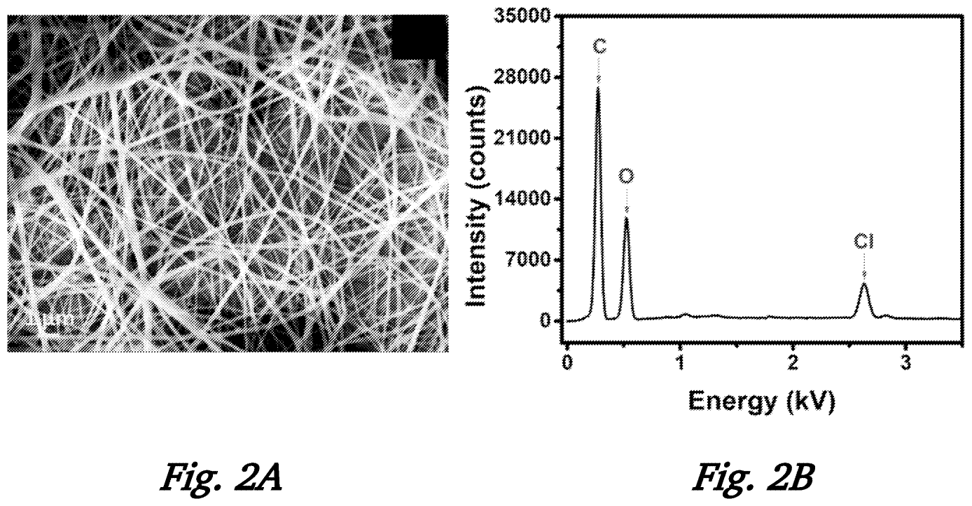

The morphology and elemental analysis of the fabricated LiCl nanofibers (LCNF) are demonstrated in FIGS. 1A-1B. The field emission scanning electron microscope (FE-SEM) image of as-fabricated LCNF shows uniform nanofibers without any imbedded particles as shown in FIG. 2A. Also, the EDX elemental mapping reveals the submergence of LiCl ions in the fibrous structure (FIG. 2B). Due to its very low energy of characteristic radiation, Li is not easily detectable in EDX. Note the absence of any additives or impurities.

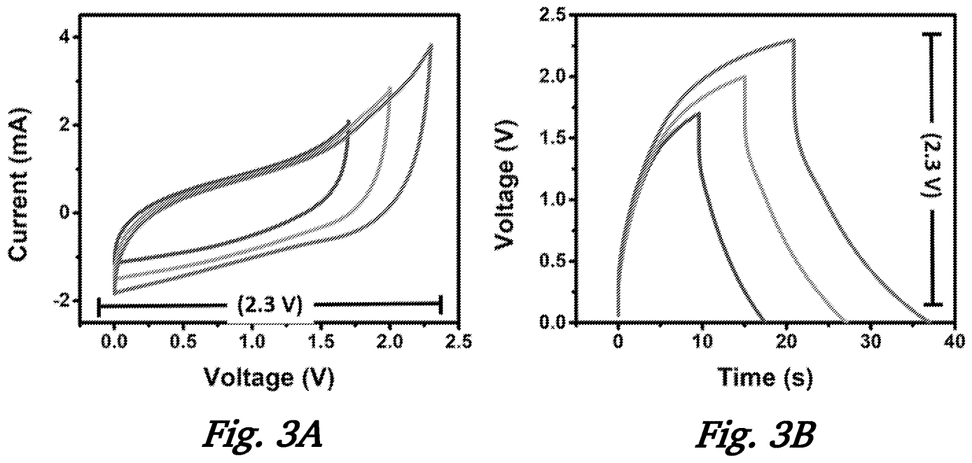

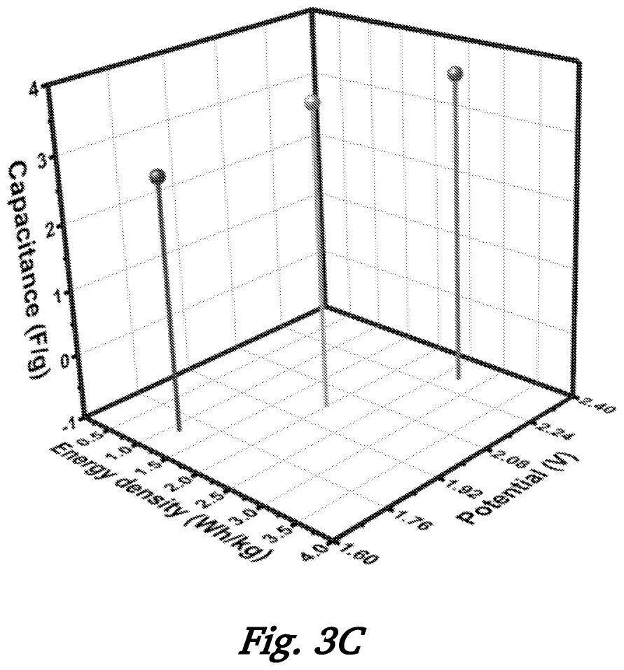

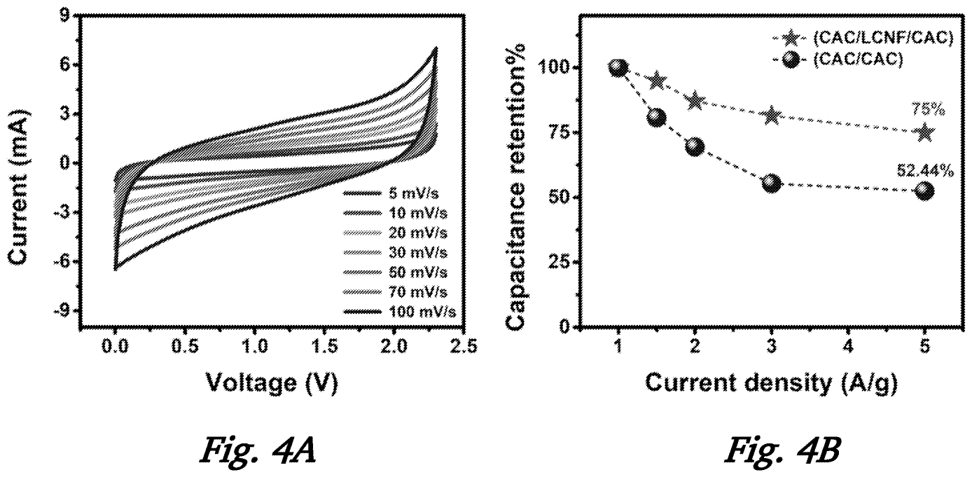

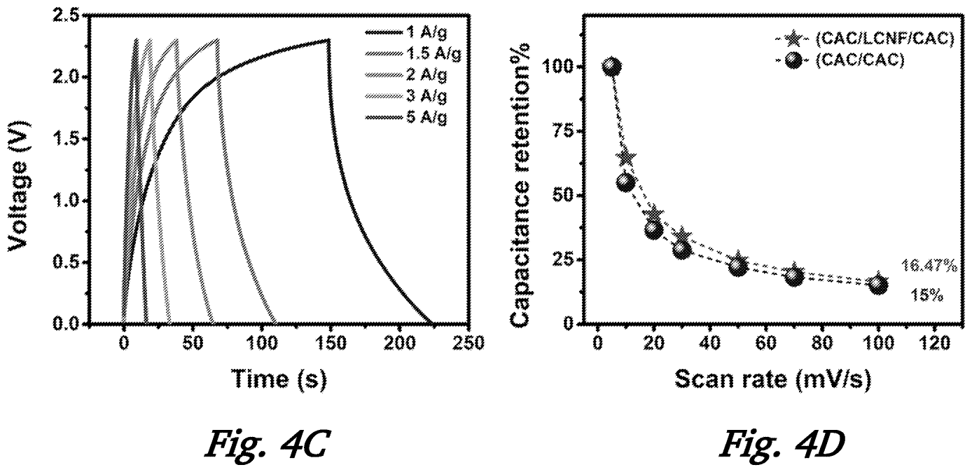

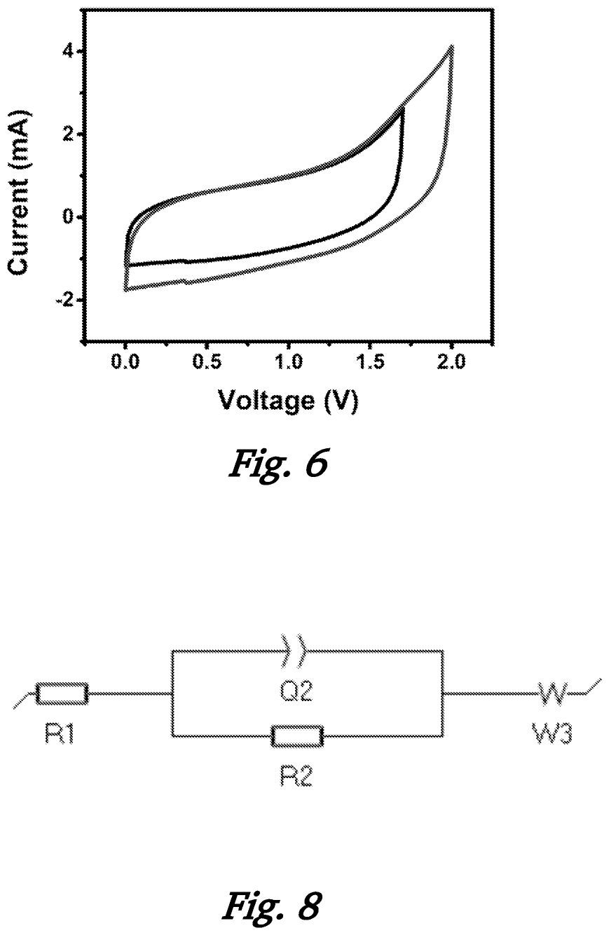

The electrochemical performance of the fabricated solid (CAC/LCNF/CAC) and aqueous (CAC/AQ/CAC) electrolyte-based devices was examined using cyclic voltammetry (CV), galvanostatic charge/discharge (GCD), and potentiochemical impedance spectroscopy (PEIS). FIGS. 2A, 2B, 2C depict the performance of the CAC/LCNF/CAC device in different potential windows. FIGS. 2A, 2B show the CV at 20 mV/s and the GCD at 1 A/g for the CAC/LCNF/CAC device in different potential ranges from 1.7 to 2.3 V. The CV exhibits rectangular shape upon increasing the potential window. Moreover, the GCD curves reveal stable charge/discharge behavior upon enlarging the operating potential window to 2.3 V with distortion in the ideal EDL performance that is usually ascribed to handling issues during the fabrication of solid state devices. The assembled aqueous electrolyte-based device showed a limited working potential window of 1.8 V (see FIG. 6 which shows current-voltage graphs at different operating potential windows of the assembles CAC/AQ/CAC device.). FIG. 3C shows the effect of enlarging the potential window on both capacitance and energy density. As the potential window is extended to 2.3 V, the specific capacitance and energy density were enhanced by 23.7% and 59%, respectively.

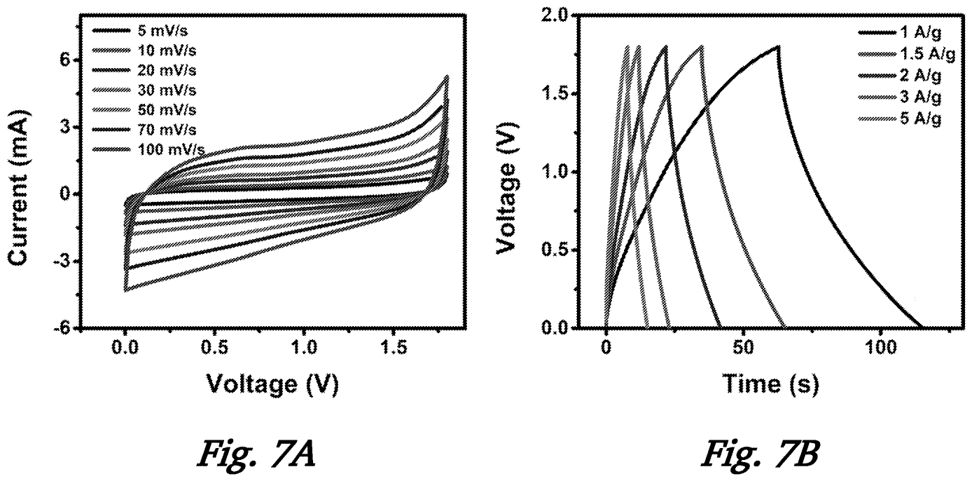

To investigate the full performance of the CAC/LCNF/CAC device, FIGS. 3A, 3B show the CVs at different scan rates from 5 to 100 mV/s and the corresponding rate capability, respectively. The CVs of the fabricated solid-state device showed rectangular shapes, revealing EDL capacitive storage mechanism with minor deviation at high scan rate (100 mV/s), indicating the high competency and stability of the devices. The device exhibited high specific capacitance of 56.43 F/g at 5 mV/s, which is dropped to 9.30 F/g at lower diffusion rate of 100 mV/s, resulting in a capability of 16.47%. Note that this capability is very close to that recorded for the aqueous electrolyte-based device. The high capacitance drop for both devices can be ascribed to the difficulty of ions diffusion into the pores of the active material at such very high scan rates. FIGS. 3C, 3D depict the GCDs and the corresponding rate capabilities of the assembled devices acquired at different current densities from 1 to 5 A/g. The GCD curves possess asymmetric triangular shape, which can be ascribed to the system internal resistance. The CAC/LCNF/CAC device showed a specific capacitance of 17.67 F/g at 1 A/g, which is dropped to 13.24 F/g at 5 A/g, reveling an excellent rate capability of 75% and high stability compared to the aqueous electrolyte-based device (52.44%). The full performance of the aqueous-based device is depicted in FIG. 7A which shows current-voltage graphs at different scan rates (5-100 mV/s) and FIG. 7B which shows GCD graphs at different current densities (1-5 A/g) for the assembled AC/AQ/CAC devices.

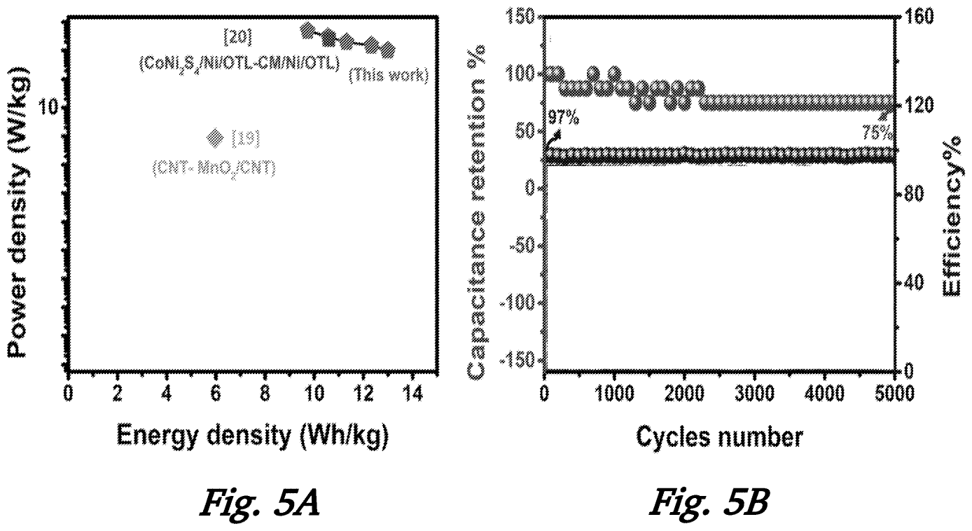

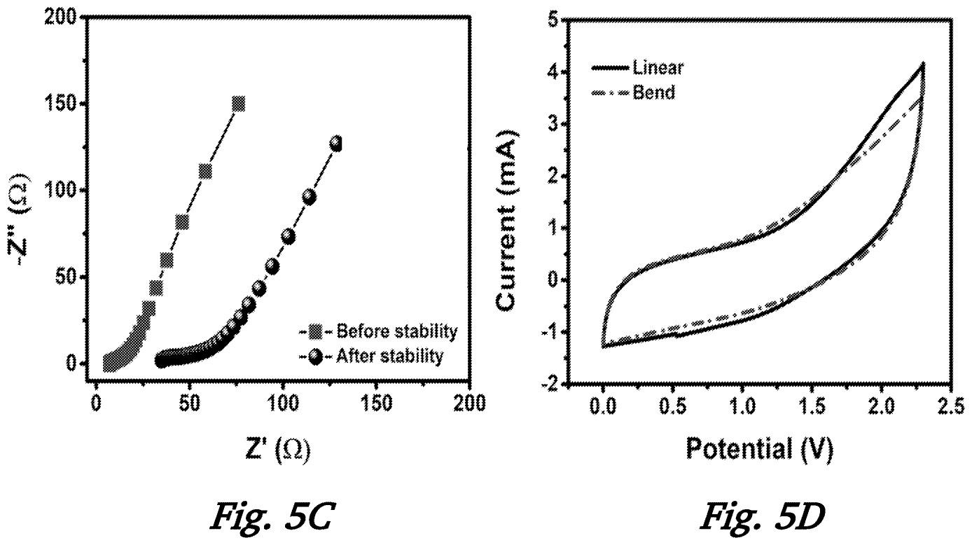

The power density and the corresponding energy density are depicted in the Ragon's plot shown in FIG. 5A. The CAC/LCNF/CAC device showed a high energy density of ˜13 Wh/kg at a power density of ˜1000 W/kg. The cyclic stability of the device was investigated at a current density of 3 A/g, FIG. 5B. The solid-state device showed outstanding performance during the first ˜2500 charge/discharge cycles with a slight drop afterwards. This outstanding performance can be ascribed to the presence of the fibrous structure that provides facile ionic transportation track for ions, making a more facile path for ionic diffusion and absorption into the active material porous structure. However, the slight capacitance drop upon extended cycling can be attributed to changes in the fibrous morphology during the electrochemical measurements as a result of the system internal heat. This was confirmed via FE-SEM imaging after cycling (inset in FIG. 5B), which indicates cross-linking of the nanofibrous structure, causing an alternation of the ionic path, thus providing more resistive pathway for ions diffusion.

To get more insights into the CAC/LCNF/CAC device performance, PEIS measurements was carried out before and after the stability test as shown in FIG. 5C with the corresponding equivalent circuit depicted in FIG. 8, which is a schematic diagram showing an impedance equivalent circuit of the device. The fresh CAC/LCNF/CAC device showed a small solution resistance (Rₛ) of 5.50Ω and a small charge transfer resistance (R_{CT}) of 2.33Ω with a linear Warburg tail indicating diffusion-controlled process. However, upon cycling, the Rs increased to 31.66Ω with an increase in the R_{CT} to 24.22Ω and deviation of the Warburg tail from linearity, which are in agreement with the obtained stability results and the FE-SEM imaging after cycling. Moreover, the CAC/LCNF/CAC device showed a high columbic efficiency of 97%, revealing the excellent reversible performance of the device. To confirm the flexibility of the assembled device, the bending text was carried. FIG. 5D, compares the CV behavior of the device before and after bending, indicating very minor change, revealing significant promise as flexible energy storage device.

We have described and demonstrated the ability to fabricate all-solid-state supercapacitor devices through the synthesis of electrospun nanofibrous electrolyte. The morphology and elemental distribution of the electrolyte were confirmed via FE-SEM and EDX elemental mapping analyses. Despite the very low concentration of LiCl (0.1M), the fabricated solid-state device showed an ultrahigh operating potential window of 2.3 V, resulting in an increase in the specific capacitance and energy density of 23.7% and 59%, respectively compared to the aqueous electrolyte-based device assembled and tested under the same conditions. The solid-state device showed a highest energy of ˜13 Wh/kg and a highest power density of 5000 W/kg, respectively. The all-solid-state device showed ultrahigh columbic efficiency of 97% with reasonably good stability over 5000 cycles. We hope this study will pave the way for fabricate more solid electrolytes via the demonstrated facile method for a plethora of devices and systems.

### EXPERIMENTAL DETAILS

Materials. Commercial activated carbon was purchased from Xinruida, polyvinylidene difluoride (PVDF) binder was obtained from Alfa Aesar, N—N dimethylfromamide (DMF) and lithium chloride (LiCl, 99%) were purchased from LOBA Chemie), polyvinyl alcohol (PVA) with a molecular weight of (85000-124000) was purchased from Techno PharmChem, graphite sheets with 0.3 mm thickness were obtained from Xinruida.

Fabrication of solid-state devices: Commercial activated carbon-based electrodes were fabricated by adding 90% of the active material to a homogenous solution consisting of DMF and 10% PVDF. A micropipette was used to cast the slurry onto graphite sheet (current collector) with 1×1 cm² dimension. Electrodes were left to dry overnight in a normal electric oven at 60° C. and labeled as (CAC). A 1 M of LiCl was added to 10 g of 10% PVA (W/V) and loaded into a plastic 6 ml syringe. The syringe diameter and working distance were kept at 13 and 150 mm, respectively. The LiCl nanofibers (LCNF) were formed upon applying a high voltage of 25 kV at a feed rate of 0.4 ml/h. The CAC-based solid-state devices were fabricated by assigning two equal masses of CAC electrodes as positive and negative terminals, and the as-produced LCNF as separator and ions source (electrolyte). The fabricated device is labeled CAC/LCNF/CAC.

Physicochemical Characterization. The fibrous LCNF structure before and after electrochemical measurements was examined using field emission scanning electron microscope (FE-SEM; Zeiss SEM Ultra 60). Also, mapping energy-dispersive X-ray (EDX; Oxford ISIS 310, England spectroscopy) was used to check the homogeneous distribution of the elemental components in the fabricated LCNF nanofibers layer.

Electrochemical Measurements. The electrochemical performance of the assembled devices using solid and aqueous electrolytes was investigated using Biologic SP 300 potentiostat. All electrochemical measurements were carried out at room temperature (22±2° C.) in 0.1 M LiCl or equivalent molarity. The specific capacitance (Cₛ) was calculated from cyclic voltammetry (CV) and from galvanostatic charge/discharge (GCD) according to Eqs. 1 and 2, respectively. The device-specific energy density (E) was calculated using Eq. 3 and the device power density (P) was calculated from Eq. 4.

$$C s = \frac{\int I dV}{v m ( Δ V )} \qquad ( 1 )$$

$$Cs = \frac{{I}_{d} Δ t}{ΔV m} \qquad ( 2 )$$

$$E = \frac{{C}_{s} Δ {V}^{2}}{7.2} \qquad ( 3 )$$

$$P = \frac{E}{Δ t} \times 3600 \qquad ( 4 )$$

where ΔV is the potential limit (V), v is the potential scan rate (mV/s), m is the active mass of the electrode material (g), I is the responded current (A), Δt is the discharging time(s), I_{d} is the discharging current (A), and V refers to the potential window after correction the IR drop.

Fabrication of aqueous based devices. A symmetric commercial activated carbon (CAC) based device was fabricated as follows.

Aqueous-state: The (CAC/CAC) was fabricated by placed two equal masses electrodes of CAC as positive and negative poles, electrodes separated by thin cellulose filter paper to avoid short circuit, and 0.1 M aqueous LiCl is used as electrolyte.

1. A solid-state supercapacitor comprising:
a solid-state electrolyte consisting of an electrospun nanofiber sheet impregnated with a salt;
a symmetric pair of electrode sheets;
wherein the solid-state electrolyte is sandwiched between and in contact with the symmetric pair of electrode sheets such that the solid-state electrolyte separates the electrode sheets from each other.

2. The solid-state supercapacitor of claim 1
wherein each of the symmetric pair of electrode sheets is composed of commercial activated carbon on a graphite substrate.

3. The solid-state supercapacitor of claim 1
wherein the salt is a salt of Li, Cs or Rb.

4. The solid-state supercapacitor of claim 1
wherein the salt is LiCl.
